(19) United States
(12) Patent Application Publication
(10) Pub. No.: US 2007/0265374 A1
(43) Pub. Date: Nov. 15, 2007

(54) Composition with zinc hydroxide, mixture containing the composition and article made therefrom

(76) Inventors: Burkhardt Jahn, Bad Harzburg (DE); Sven Hessdoerfer, Karlstadt / Main (DE); Nikolaus Rennar, Unterpleichfeld (DE)

Correspondence Address: JACOBSON HOLMAN;PROFESSIONAL LIMITED LIABILITY COMPANY, 400 SEVENTH STREET, N. W., WASHINGTON, DC, 20004, US

(21) Appl. No.: 11/727,164

(22) Filed: Mar. 23, 2007

Related U.S. Application Data
(60) Provisional application No. 60/784,762, filed on Mar. 23, 2006.

(30) Foreign Application Priority Data
Mar. 23, 2006 (EP) 06 111 635.6

(51) Int. Cl. C08K 3/32; C08L 91/08

(52) U.S. Cl. 524/62; 524/106; 524/186; 524/414; 524/424; 524/434; 524/99

(57) ABSTRACT

A composition is disclosed which contains at least one diene rubber or at least one copolymer of a diene rubber and/or mixtures and zinc hydroxide and/or basic zinc carbonate and/or zinc phosphate. The composition is suitable as a masterbatch and can be employed for the preparation of vulcanizable mixtures with a lower zinc load.

The invention relates to a composition with zinc hydroxide, basic zinc carbonate and/or phosphate, mixtures containing the composition, a process for preparing the composition, articles made from the mixture according to the invention, and the use of non-calcined zinc hydroxide, basic zinc carbonate and/or zinc phosphate.

Due to their technologically interesting property profile, elastomers hold a key position among the different groups of materials. Rubber materials which are reversibly deformable within wide limits and have a medium performance spectrum, i.e., wide-meshed chemically cross-linked polymers, can usually be prepared by the “vulcanization” of diene rubbers in the simplest case. “Vulcanization” designates a special kind of cross-linking whereby the individually interlooped, but chemically non-cross-linked macromolecules of the plastic rubber become covalently linked in a wide-meshed way through multiatom sulfur bridges.

The oldest and at the same time still most important vulcanization agent is still sulfur. However, to achieve particular mechanical strength values, chemical and dynamical-mechanical properties, but also to accelerate the actual cross-linking reaction, the addition of organic vulcanization accelerators, activators and fatty acids as well as further rubber additives (fillers, plasticizers, processing aids, ageing protectors etc.) is indispensable. Of great advantage for the industrial use of the vulcanization process is the relative insensitivity of the (accelerated) sulfur cross-linking towards most components of the mixture and towards water and oxygen. In addition, what is characteristic of this process is the high economic efficiency of the process and the excellent controllability of the vulcanization rate by means of accelerator and decelerator and by means of the process parameters cross-linking temperature and cross-linking time, which are relatively easily adjusted. The possibility of influencing the length and structure of the cross-links simultaneously by the kind and amount of decelerators and by the sulfur dosing is further important to this process. Thus, for example, the formation of either predominantly polysulfidic cross-links with good elastic properties and a high tensile strength of the vulcanizates or predominantly mono- or disulfidic cross-links with a good heat resistance of the vulcanizates can be achieved. The skilled person is familiar with knowledge about the optimization of a given sulfur-accelerator system under consideration of processing safety, time and temperature of vulcanization, the kind of cross-linking and the desired technological properties.

Until today, the mechanism of sulfur vulcanization has been the subject of numerous studies. In principle, a distinction must be made between the technologically little important accelerator-free vulcanization and the technically relevant accelerated vulcanization using sulfur-accelerator systems and activators. It is known that metal oxides in combination with fatty acids have an activating effect on sulfur-accelerator systems. Often, zinc oxide is used as an activator, but lead oxide and magnesium oxide are also employed. However, the role of zinc oxide is not limited only to the role of a vulcanization activator in sulfur cross-linking; ZnO may also serve the following functions:
cross-linking agent for halogen-containing rubbers;
cross-linking agent for polymers containing carboxy groups (“salt cross-linking”);
acid scavengers in peroxide cross-linking;
light-colored filler for improving the elastic properties and the heat resistance upon dynamic load.

Although the rubber-processing industry has employed zinc oxide successfully in the vulcanization of rubbers for decades only in moderate doses and in combination with fatty acids, demands for a reduction of the zinc oxide content in rubber articles because of a potential load on the environment with this heavy metal have grown louder recently. GB 1,447,115 and GB 239,173 disclose a use of zinc hydroxide as vulcanization activator. DE 198 15 453 A1 discloses filler containing rubbers in form of free-flowing after mechanical stressed. Furthermore, is disclosed a process for the preparation of such rubbers wherein the rubber powder is obtained in the course of two precipitation steps. EP 1,505,115 A discloses a composition containing nano-scalled zinc oxide particles. The object of the invention is to provide a vulcanization activator which is loaded with lower amounts of heavy metals. The vulcanization activator to be provided is further supposed to have the following properties:
high vulcanization-active efficiency;
no negative influence on the ageing performance of the vulcanizates;
being readily dosed;
good dispersibility in the rubber mixture;
no formation of filler specks;
no or little evolution of dust;
chemical resistance;
good shelf stability even at elevated temperatures of the environment.

Another object is to provide the vulcanization activator in form of master batches.

This object is achieved by a composition containing:
a) at least one polymer component selected from the group consisting of at least one diene rubber, at least one bipolymer of a conjugated diene and an aromatic vinyl compound, a bipolymer of a conjugated diene and a monoolefinic monomer, a corresponding terpolymer or combinations thereof, wherein the terpolymer is obtainable from a diene, an aromatic vinyl compound and a monoolefinic monomer; and
b) zinc hydroxide, basic zinc carbonate, zinc phosphate or combinations thereof.

A composition as obtainable by adding a polymer dispersion to an alkaline solution containing zincate whereby zinc hydroxide, basic zinc carbonate and/or zinc phosphate as well as a rubber is participated concertedly.

The composition according to the invention can be formulated in the form of a masterbatch as a vulcanization activator in the rubber industry. The composition according to the invention can be employed for the preparation and use of masterbatches from a rubbery polymer and zinc hydroxide, basic zinc hydroxide, zinc phosphate or combinations thereof obtained by wet chemistry, which serve as vulcanization activators having more efficient cross-linking characteristics in the accelerated sulfur cross-linking of diene rubbers and thus lead to a reduction of the potential load on the environment from heavy metals.

According to the invention and contrary to the prior art of GB 1,447,115 and GB 239,173 a polymer dispersion or latex is added to an alkaline zinc solution. The process of the invention demands the concerted participation of the zinc compounds. Due to the process of preparation of the zinc compounds according to the invention they do not show a specific BET-surface and do not show very small particle sizes.

In one embodiment of the composition according to the invention, it contains a conjugated diene and an aromatic vinyl compound, a conjugated diene and a monoolefinic monomer, a corresponding terpolymer or combinations thereof as said bipolymer, the terpolymer being obtainable from a diene, an aromatic vinyl compound and a monoolefinic monomer.

In a further embodiment, the zinc hydroxide, basic zinc carbonate and/or zinc phosphate are solids precipitated by wet chemistry.

According to the invention, the diene rubber can be composed of diene rubber monomers selected from the group consisting of butadiene-1,3, isoprene, 2,3-dimethylbutadiene-1,3, chloroprene, pentadiene-1,3, hexadiene and mixtures thereof.

The aromatic vinyl monomers may be selected from the group consisting of styrene, α-methylstyrene, p-methylstyrene, o-methylstyrene, p-butylstyrene, vinyinaphthalene and mixtures thereof.

According to the invention, a monomer selected from the group consisting of acrylonitrile, methacrylonitrile and mixtures thereof can be employed as the monoolefinic monomer.

The composition according to the invention contains, for example, from 10 to 90 weight parts of polymer, especially from 40 to 60 weight parts of polymer, and from 90 to 10 weight parts of zinc hydroxide, basic zinc carbonate and/or zinc phosphate, especially from 60 to 40 weight parts of zinc hydroxide and/or zinc carbonate and/or zinc phosphate.

Usually, the composition according to the invention can be formulated in the form of sheets and/or pellets if employed as a masterbatch. Masterbatches have the advantage of a standardized composition, which results in an easy handling property in the industrial production process.

A process for the preparation of the composition according to the invention is also claimed according to the invention. In this process, a polymer dispersion is added to an alkaline zincate solution, and zinc hydroxide, basic zinc carbonate, zinc phosphate or their combinations as well as rubber (if a latex is employed) are precipitated.

In one embodiment of the process according to the invention, a diluted aqueous alkaline zincate solution having a zinc content of from 0.4 to 1.6 mol/l is employed. As the polymer dispersion, for example, a polymer latex having a solids content of from 3 to 300% by weight, especially from 3 to 10%/o by weight, is employed.

In a particular embodiment of the process according to the invention, zinc hydroxide and/or basic zinc carbonate and/or zinc phosphate as well as rubber are simultaneously precipitated in a finely distributed form with stirring by lowering the pH value. The lowering of the pH value is effected, for example, by adding a Brønsted acid or by introducing carbon dioxide gas. The Brønsted acid if used is selected, for example, from the group consisting of hydrochloric acid, sulfuric acid, phosphoric acid or acetic acid.

The invention also relates to a vulcanizable mixture which comprises the composition according to the invention. In particular, the vulcanizable mixture according to the invention contains:

a) the composition according to the invention;

b) at least one further matrix rubber;

c) cross-linking agents;

d) optionally fillers;

e) optionally plasticizers;

f) optionally ageing protectors;

g) optionally further rubber additives.

Said further matrix rubber is, for example, a diene rubber and/or diene rubber copolymer.

The mixture according to the invention is provided with, for example, 100 weight parts of matrix rubber, from 0.5 to 10 weight parts of the composition according to any of claims 1 to 7, from 0 to 90 weight parts of fillers, from 0 to 50 weight parts of plasticizer.

The cross-linking agent is, for example, sulfur or a sulfur donor and mixtures thereof.

In one embodiment of the invention, the filler is a finely distributed black or light-colored active filler. A fine distribution of the fillers is achieved by breaking up filler beads and agglomerates during the mixing process, infiltrating them with polymer, and distributing the resulting aggregates of 20-350 nm in size homogeneously in the rubber mixture, for example, by disperse and distributive mixing. An active (reinforcing) filler can considerably increase the viscosity of the mixture by interacting with the rubber matrix, and also improves the breaking performance of the vulcanizate. Thus, as a rule, a steady decrease of the breaking energy density (integral of the stress-strain curve) is observed with increasing filler content for inactive fillers, but a maximum thereof is observed for active fillers.

The ageing protector for the mixture according to the invention is selected, for example, from the group consisting of p-phenylene diamine derivatives, dihydroquinoline derivatives, naphthylamine derivatives, diphenylamine derivatives, benzimidazole derivatives, bisphenol derivatives and monophenol derivatives.

The plasticizer for the mixture according to the invention is selected, for example, from the group consisting of aromatic, naphthenic, paraffinic mineral oil plasticizers as well as synthetic plasticizing oils, such as ester, ether and polymer plasticizers and halogenated paraffins. The further usual rubber additives may be selected from the group consisting of processing aids, such as soaps, waxes, resins; other additives, such as colorants, blowing agents, flame protectors, bonding agents, antistatic agents; vulcanization accelerators, vulcanization decelerators. The invention also relates to a process for preparing the mixture according to the invention, wherein the components are processed with mixing apparatus, such as interior mixer, open roll mill, extruder.

The invention further relates to articles obtainable by vulcanizing the vulcanizable mixture according to the invention.

For example, vehicle tires, conveying belts, transmission belts, spring elements, profiles, seals, flexible tubes, bladders, rolls, medical articles, sporting articles, rubber shoes and soles, cables may be prepared as articles according to the invention.

The invention also relates to the use of the mixture according to the invention for the preparation of vehicle tires, technical rubber articles, and to the use of non-calcined zinc hydroxide as a vulcanization activator.

The invention will be further illustrated by means of the following Examples.

### EXAMPLE 1

100 g of zinc oxide is suspended with about 400 ml of deionized water, and with stirring and optionally heating, 1.5 to 2 times the equimolar amount of semiconcentrated sulfuric acid is added in portions; any undissolved fractions are separated off by filtration. To the resulting clear zinc salt solution, concentrated aqueous sodium hydroxide (about 12.5 M) is now flowed in from a dropping funnel with intensive stirring until the solution has a pH of about 7. The forming amorphous precipitate is separated off by vacuum filtration, resuspended with deionized water and again separated off. This procedure is repeated until the washing water no longer shows turbidity with barium chloride solution. The filter cake separated off by vacuum filtration, while still wet, is now suspended in a little water. With intensive stirring and optionally with slight heating, concentrated aqueous sodium hydroxide (about 12.5 M) is added in such an amount that the whole solids become almost completely dissolved; any undissolved fractions are separated off by filtration. Now, 1300 ml of the thus obtained alkaline, about 0.7 M zinc solution is successively mixed with 785 ml of a diluted oil-free styrene-butadiene latex (solids content about 7% by weight) with intensive stirring; the subsequent addition of semiconcentrated sulfuric acid lowers the pH to <6. When an optimum operation method is effected, a finely divided amorphous precipitate is formed which is separated from the supernatant solution by filtration or centrifugation and repeatedly washed out thoroughly. The solid is subsequently carefully dried at 70° C. in a vacuum drying oven, and in the last processing step, it is compacted on an open roll mill (optionally with adding about 5-10% by weight of a plasticizer oil) into a contiguous mixture sheet, and pelletized if needed.

### EXAMPLE 2

100 g of zinc oxide is intensively mixed with double the amount of powderized sodium carbonate (alternatively a 1:1 mixture of powderized sodium and potassium carbonates) and calcined in a refractory crucible at a temperature of from 1000 to 1100° C. in a muffle furnace for twelve hours. The cooled-down, mechanically comminuted sinter product is repeatedly leached with hot aqueous sodium hydroxide, and the undissolved residue is separated off by filtration. Now, 900 ml of the thus obtained alkaline, about 0.7 M zinc solution is successively mixed with 785 ml of a diluted natural rubber latex (solids content 4% by weight) with intensive stirring; the subsequent introduction carbon dioxide gas lowers the pH to <6. The finely divided amorphous precipitate formed is separated from the supernatant solution by filtration or centrifugation and repeatedly washed out. The solid, while still wet, is subsequently dried at 70° C. in a vacuum drying oven and compacted into a contiguous mixture sheet (if needed, with the addition of 5-10% by weight of a plasticizer oil), and optionally pelletized.

### EXAMPLE 3

100 g of zinc oxide is intensively mixed with 120 g of powderized sodium hydroxide and heated in a refractory crucible with a cover for three hours by means of a blower or in a muffle furnace to form a clear melt flow. The cooled-down melting cake is comminuted mechanically, repeatedly leached with boiling water and filtrated from the undissolved residue. Now, 1100 ml of the thus obtained alkaline zinc solution is successively mixed with 800 ml of a diluted acrylonitrile-butadiene latex (solids content <10% by weight) with intensive stirring; the subsequent introduction carbon dioxide gas lowers the pH to <5.5. A finely divided amorphous precipitate is formed which is separated from the supernatant solution by filtration or centrifugation and repeatedly washed out thoroughly. The solid, while still wet, is subsequently dried at 70° C. in a vacuum drying oven and compacted into a contiguous mixture sheet (if needed, with the addition of 5-10% by weight of a plasticizer oil), and optionally pelletized.

1: A composition containing:
a) at least a polymer component selected from the group consisting of at least one diene rubber, at least one bipolymer of a conjugated diene and an aromatic vinyl compound, a bipolymer of a conjugated diene and a monoolefinic monomer, a corresponding terpolymer or combinations thereof, wherein the terpolymer is obtainable from a diene, an aromatic vinyl compound and a monoolefinic monomer; and
b) zinc hydroxide, basic zinc carbonate, zinc phosphate or combinations thereof.

2: The composition according to claim 1, wherein said diene rubber is composed of diene rubber monomers selected from the group consisting of butadiene-1,3, isoprene, 2,3-dimethylbutadiene-1,3, chloroprene, pentadiene-1,3, hexadiene and mixtures thereof.

3: The composition according to claim 1, wherein said aromatic vinyl monomers of the bipolymer are selected from the group consisting of styrene, α-methylstyrene, p-methylstyrene, o-methylstyrene, p-butylstyrene, vinylnaphthalene and mixtures thereof.

4: The composition according to at claim 1, wherein said monoolefinic monomer of the bipolymer is selected from the group consisting of acrylonitrile, methacrylonitrile and mixtures thereof.

5: The composition according to claim 1, wherein said zinc hydroxide,
basic zinc carbonate and/or zinc phosphate are solids precipitated by wet chemistry.

6: The composition according to claim 1 with from 10 to 90 weight parts of polymer, especially from 40 to 60 weight parts of polymer, and from 90 to 10 weight parts of zinc hydroxide, basic zinc carbonate and/or zinc phosphate, especially from 60 to 40 weight parts of zinc hydroxide, basic zinc carbonate and/or zinc phosphate.

7: The composition according to claim 1 in the form of sheets and/or pellets.

8: A process for the preparation of the composition according to claim 1, characterized in that a polymer dispersion is added to an alkaline zincate solution, and zinc hydroxide, basic zinc carbonate and/or zinc phosphate as well as rubber are precipitated.

9: The process according to claim 8, wherein a diluted aqueous alkaline zincate solution having a zinc content of from 0.4 to 1.6 mol/l is employed.

10: The process according to claim 8 and/or 9, wherein a polymer latex having a solids content of from 3 to 30% by weight, especially from 3 to 10% by weight, is employed as said polymer dispersion.

11: The process according to claim 8, wherein zinc hydroxide, basic zinc carbonate and/or zinc phosphate as well as rubber are simultaneously precipitated in a finely distributed form with stirring by lowering the pH value.

12: The process according to claim 11, wherein said lowering of the pH value is effected by adding a Brønsted acid or by introducing carbon dioxide gas.

13: The process according to claim 12, wherein said Brønsted acid is selected from the group consisting of hydrochloric acid, sulfuric acid, phosphoric acid or acetic acid.

14: A vulcanizable mixture, containing:
a) the composition according to claim 1;
b) at least one further matrix rubber;
c) cross-linking agents;
d) optionally fillers;
e) optionally plasticizers;
f) optionally ageing protectors;
g) optionally further rubber additives.

15: The mixture according to claim 14, wherein said further matrix rubber is a diene rubber and/or diene rubber copolymer.

16: The mixture according to claim 14 with 100 weight parts of matrix rubber, from 0.5 to 20 weight parts, especially from 0.5 to 10 weight parts, of the composition according to any of claims 1 to 7, from 0 to 90 weight parts of fillers, from 0 to 50 weight parts of plasticizer.

17: The mixture according to claim 14, wherein said cross-linking agent is sulfur, a sulfur donor or mixtures thereof.

18: The mixture according to claim 14, wherein said filler is a finely distributed black or light-colored active filler.

19: The mixture according to claim 14, wherein said ageing protector is selected from the group consisting of p-phenylene diamine derivatives, dihydroquinoline derivatives, naphthylamine derivatives, diphenylamine derivatives, benzimidazole derivatives, bisphenol derivatives and monophenol derivatives.

20: The mixture according to claim 14, wherein said plasticizer is selected from the group consisting of aromatic, naphthenic, paraffinic mineral oil plasticizers as well as synthetic plasticizing oils, such as ester, ether and polymer plasticizers and halogenated paraffins.

21: The mixture according to claim 14, wherein said further usual rubber additives are selected from the group consisting of processing aids, such as soaps, waxes, resins; other additives, such as colorants, blowing agents, flame protectors, bonding agents, antistatic agents; vulcanization accelerators, vulcanization decelerators.

22: A The process for preparing the mixture according to claim 14, wherein the components are processed with mixing apparatus, such as interior mixer, open roll mill, extruder.

23: An article obtainable by vulcanizing the vulcanizable mixture according to claim 14.

24: The article according to claim 23 selected from the group consisting of vehicle tires, conveying belts, transmission belts, spring elements, profiles, seals, flexible tubes, bladders, rolls, medical articles, sporting articles, rubber shoes and rubber soles, cables.

25: Use of the mixture according to claim 14 for the preparation of vehicle tires, technical rubber articles and rubberized fabrics.

26: Use of non-calcined zinc hydroxide, non-calcined basic zinc carbonate and/or non-calcined zinc phosphate as a vulcanization activator.
